(19) United States
(12) Patent Application Publication
(10) Pub. No.: US 2004/0070119 A1
(43) Pub. Date: Apr. 15, 2004

(54) Manufacturing method for polyethylene-terephtalate containers with out-of-centre mouth

(76) Inventors: Mauro Fibbia, Casier (IT); Alberto Armellin, Vittorio Veneto (IT)

Correspondence Address: WENDEROTH, LIND & PONACK, L.L.P., 2033 K STREET N. W., SUITE 800, WASHINGTON, DC, 20006-1021, US

(21) Appl. No.: 10/467,452

(22) PCT Filed: Jan. 26, 2002
(86) PCT No.: PCT/EP02/00834

(30) Foreign Application Priority Data
Feb. 7, 2001 (IT) PN2001A000009

(51) Int. Cl. B29C 49/06; B29C 49/12; B29C 49/64

(52) U.S. Cl. 264/531; 264/535; 264/537; 264/532; 425/522; 425/526

(57) ABSTRACT

Method for manufacturing plastic bottles, including the step in which respective preforms are removed from the respective moulds, and the step in which said preforms are transferred into temperature conditioning stations for a predetermined period of time, during which said preforms are caused to undergo an asymmetrical heat treatment that is effective in heating in a different manner a preform sector having an angular spread of a definite value that is anyway not less than 180°. The method includes the step in which said surface sector of the preform is heated up with the help of heating means that are partially arranged in a crown-like manner around the respective preform. The blow-moulding process comprises the sub-steps in which: the stretching rod is inserted into the preform up to the point in which it almost comes into contact with the bottom thereof; a stretching counter-rod is approached from the outside of the preform up to the point in which it almost comes into contact with the bottom of the preform; the preform undergoes blow-moulding while, at the same time, said stretching rod moves further forward into the preform and, by in this way pressing against the bottom of the preform, pushes the stretching counter-rod in a direction of ejection from the blow-moulding cavity.

The present invention refers to a particular method for manufacturing containers of thermoplastic resin, in particular PET, that are provided with a cylindrical neck portion, on which a normal cap is then screwed, but have a body that is formed to a shape which is asymmetrical with respect to all planes passing through the axis of said neck portion of the container, with the exclusion of a single plane thereof, which therefore forms the one and single plane of symmetry of the container.

Containers of this kind are usually manufactured by initially obtaining a preform through the extrusion in an appropriate manner of a molten mass of pelletized plastic material, and then submitting such a preform to blow-moulding so as to cause it to take the desired shape of the finished container. These containers shall be called “asymmetrical” in this context for the sole reason that this is how they are usually referred to in the common practice; they are universally used in particular applications and fields of utilization that require a considerable reduction in a total available volume with respect to the sum of the volumes of a determined number of containers included in said total volume. It is a largely well-known fact that the containers featuring a good “volumetric efficiency” are those containers whose shape comes as close as possible to a parallelepiped.

In addition, such containers shall possess a good prehensility, ie. shall be particularly adapted to convenient grasping or seizing, since they are most likely to be handled by hands that may not be very well fit, ie. in a suitable condition for seizing them. As a matter of fact, typical fields of utilization of these containers are when they contain, ie. are filled with lubricant oil or detergent.

Containers of this kind are manufactured starting from fully traditional and, therefore, cylindrical preforms, although it would be possible, albeit very complicated, demanding and expensive, for these containers to be manufactured starting from preforms that are actually so shaped as to as much as possible anticipate the ultimate shape of the blow-moulded container.

However, the step in which the preforms are blow-moulded in view of obtaining said asymmetrical containers, has the following two kinds of substantial drawbacks:

the first one of these drawbacks lies in the fact that, when the preform is blown, upon of course being duly pre-heated and then closed in the cavity of a suitable and correspondingly shaped blowing mould, the same preform is stretched both downwards and radially. However, owing to the asymmetrical conformation of the cavity of the blowing mould and the substantially uniform temperature of the body of the preform, the latter, owing to its being stretched in a non-uniform manner radially, takes an uneven thickness in the side walls thereof, ie. the thickness of the side walls thereof takes an uneven pattern. In particular, in the zones undergoing the greatest extent of stretching, such a wall thickness becomes unacceptably thin, with obvious negative consequences for the durability and integrity of the container and, therefore, the contents thereof,

the second major drawbacks is connected with the downward stretching of the preform.

As a matter of fact, the actual blow-moulding step comprises following two sub-steps: a first sub-step in which an appropriate stretching rod is inserted deeply down into the preform so as to push the bottom of the preform against the matching portion, ie. the bottom of the blowing mould and, as a result, to so determine the correct height dimension of the finished container; and a second, subsequent sub-step, in which compressed air is let into the preform.

At the beginning of the above mentioned second sub-step, the bottom of the preform is blown partially. However, since the asymmetry of both the thermal configuration or pattern of the preform and the geometrical configuration of the mould is rather considerable, the fact occurs that the bottom of the preform, although it is in contact with the end portion of the stretching rod, bends to one side, thereby talking an irregular, almost curl-like shape, and in particular it bends towards the asymmetrical portion of the mould.

As a result, the end portion of the stretching rod fails to touch the bottom of the preform, but comes instead into contact with a more or less lateral zone; therefore, such a circumstance causes the blow-moulding effect to become still more irregular and uncertain, while the resulting container quite frequently exhibits distortions, deformations or even cracks that make it completely useless.

In view of being able to guide the bottom of the preform correctly, or even to the mere purpose of correctly forming the bottom of the preform during blow-moulding, even in the case of non-asymmetrical containers, a number of solutions have been found and disclosed in the art: one of these solutions, exemplified in the Japanese patent application no. 53-2296, provides for a rod (21) protruding from the bottom of the mould, is capable of penetrating into the container being moulded so as to determine in a very accurate manner the crystallization process and the thickness of the bottom of the same container.

However, such an operation is only carried out when the blowing step, and therefore the step involving the formation of the container, has already been completed, so that no teaching emerges therefrom as far as the maintenance of the correct position of the bottom of the container during blowing is concerned.

The French patent no. 2508004, granted to AOKI, discloses a solution that makes use of a contrasting and reference rod 12 that acts as an abutment on the outside of the bottom of the container during blow-moulding, in this solution, however, the purpose of said rod is completely different from the one involving the positioning of the bottom of the container, since it can be clearly inferred that such a bottom is filly stretched and, therefore, guided by the stretching rod prior to the beginning of the step in which the compressed air is let in, so that no teaching is actually given in view of maintaining the correct position of the bottom during the initial part of the blowing process, but prior to the beginning of the penetration movement of the stretching rod, since in this case blowing only starts after said stretching rod has fully moved into the preform.

A solution is known from U.S. Pat. No. 3,949,033, which is based on the use of a convex counter-rod (47) that penetrates to a certain extent from the outside of the bottom of the container after blowing, such a solution, however, has the sole purpose of generating a markedly arcuate curvature of the bottom of the container, while it does not involve any teaching as to how correctly holding the bottom of the preform during the blowing step.

Based on the above considerations, it is therefore a main purpose of the present invention, to provide a method and an apparatus adapted to generate a differentiated heating on the cylindrical wall of the preform and to provide a blowing step for an asymmetrical container, in which the position of the bottom of the preform, and therefore of the container, is accurately determined and held in an absolutely firm manner throughout the duration of the blowing step.

Such an aim of the present invention, along with further features thereof that will be described in the following description, is reached in a method and an apparatus that are made and operate as recited in the appended claims.

The present invention may take the form of a preferred, although not sole embodiment such as the one that is described in detail and illustrated below by way of non-limiting example with reference to the accompanying drawings, in which:

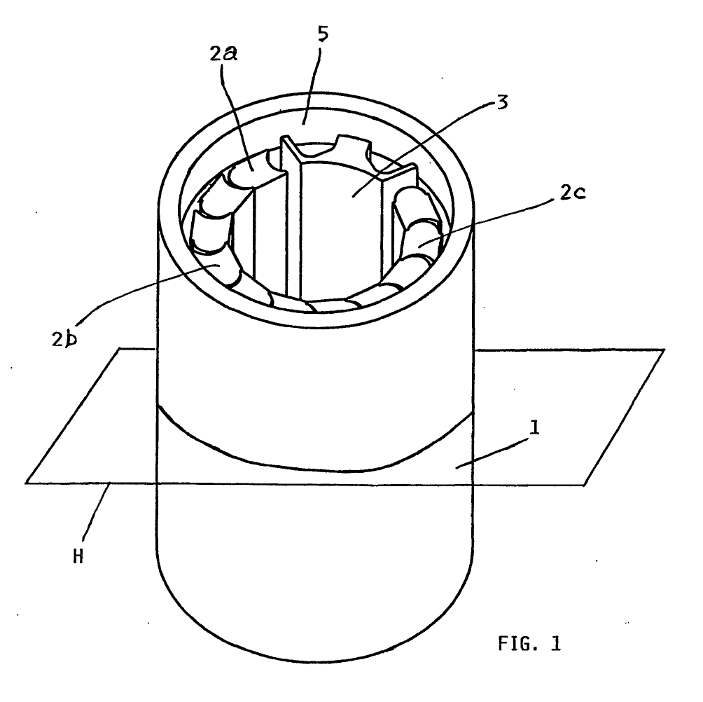

FIG. 1 is an external perspective view of a first apparatus according to the present invention;

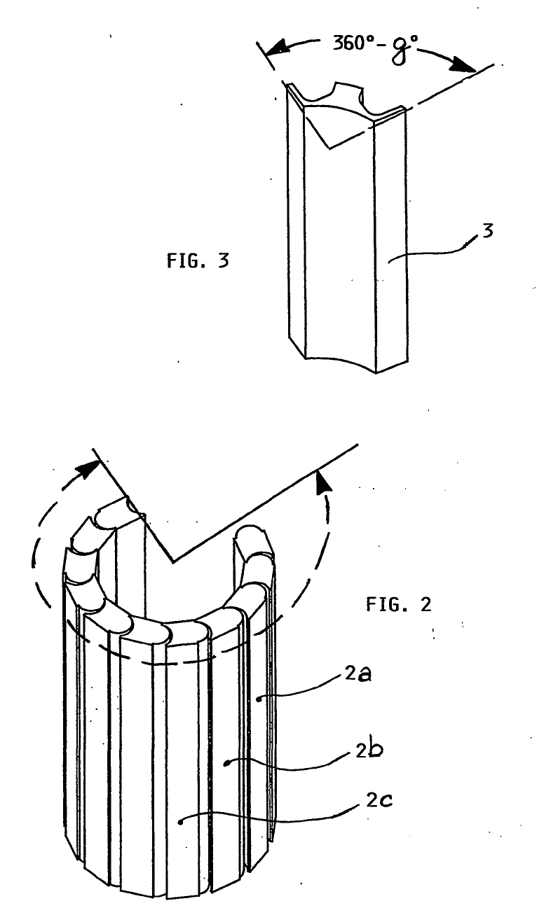

FIG. 2 is an external perspective view of a first component member of the apparatus illustrated in FIG. 1;

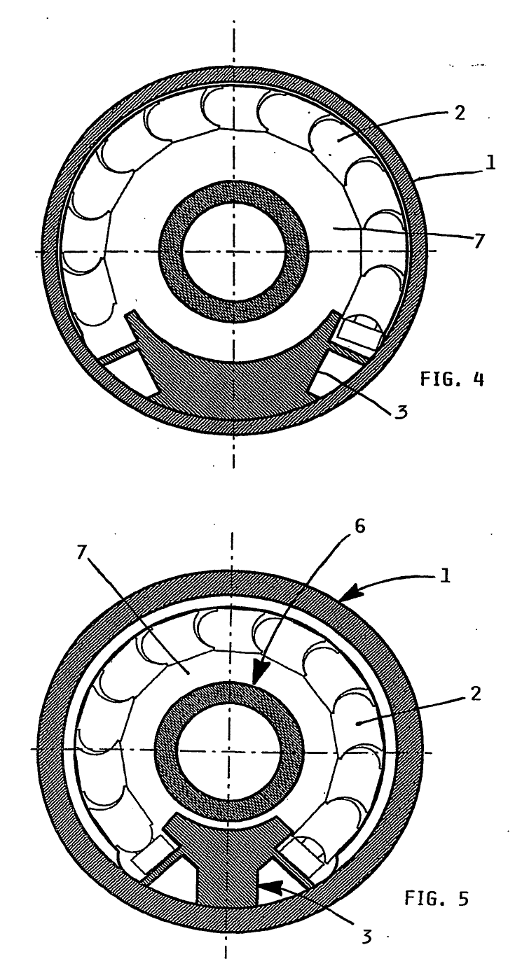

FIG. 3 is an external perspective view of a second component member of the apparatus illustrated in FIG. 1;

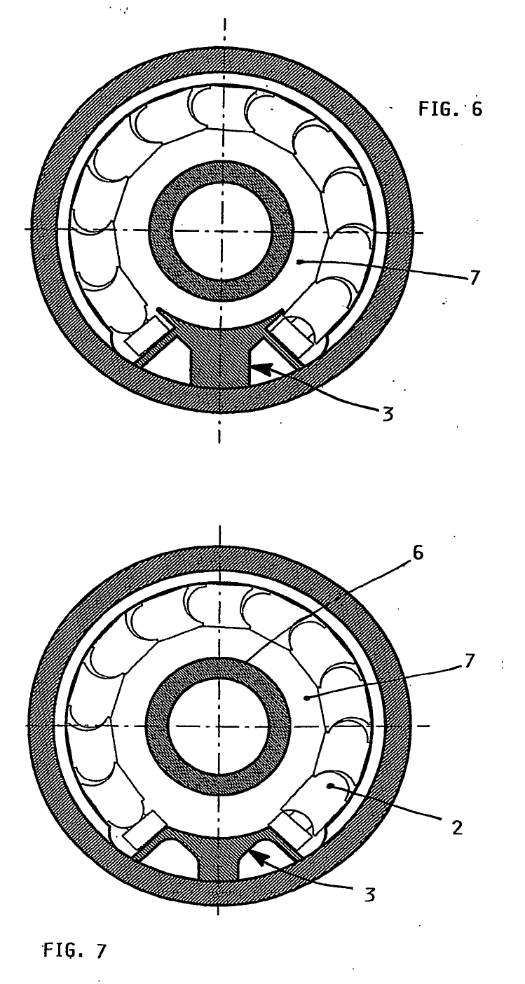

FIGS. 4 to 7 are cross-sectional views, along the plane “H” of FIG. 1, of respective variants in the embodiment of the apparatus illustrated in FIG. 1;

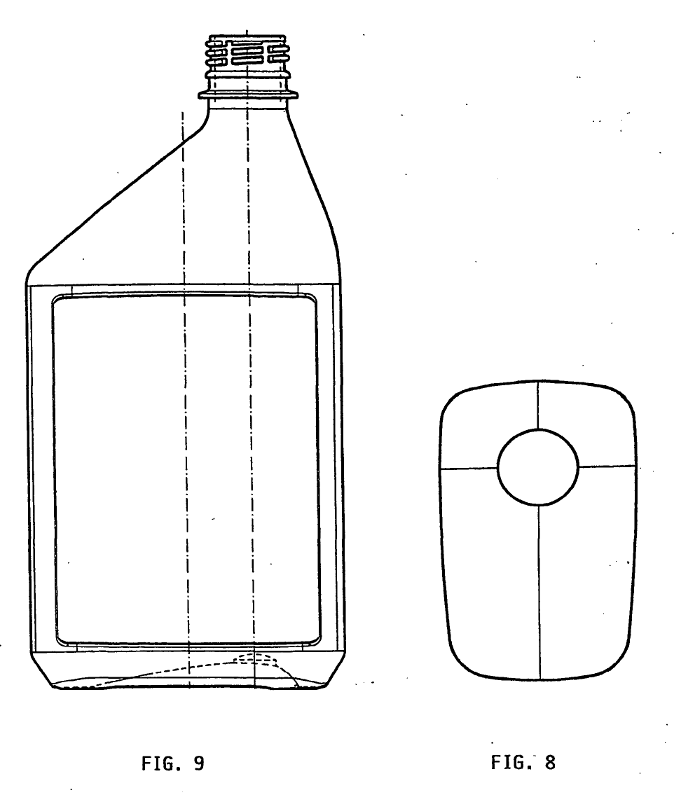

FIG. 8 is a top view of an asymmetrical bottle capable of being manufactured with the method according to the present invention;

FIG. 9 is a front, elevational view of the bottle illustrated in FIG. 8, as observed from the major side thereof;

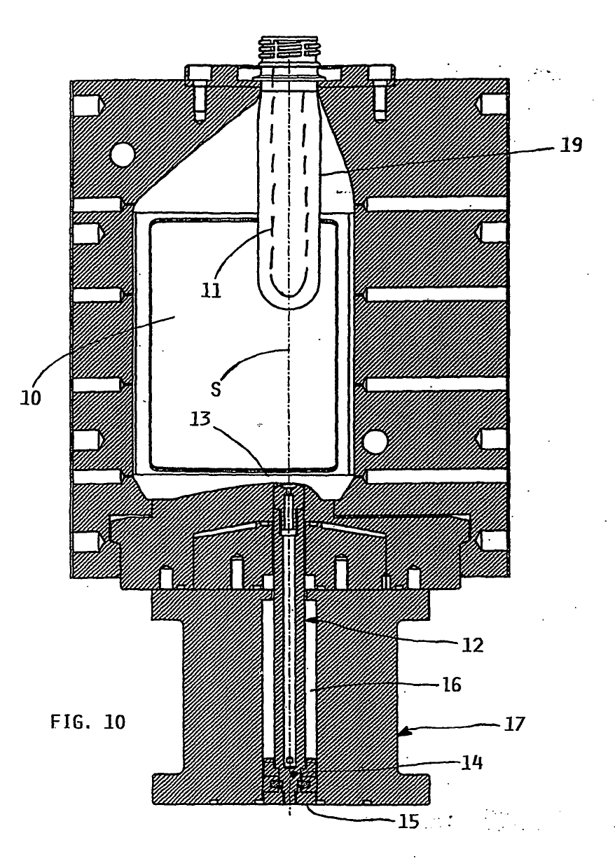

FIGS. 10 to 13 and FIG. 15 are schematical views of respective steps of a blow-moulding method and the related apparatus according to present invention;

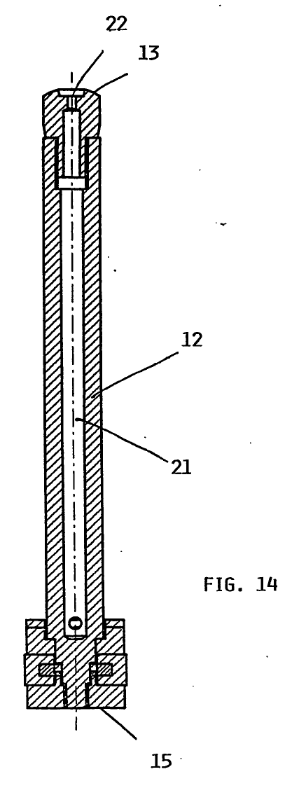

FIG. 14 is a front, elevational view of an isolated component member of the apparatus illustrated in the preceding Figures.

With reference to FIGS. 1 to 7, an apparatus for heating up in a differentiated manner the body of the preform according to the present invention comprises:

an outer cylindrical body 1,

a heating means 2 provided in the shape of a partially cylindrical sector (see FIG. 2), arranged inside said outer cylindrical body 1;

a non-heated element 3 provided to thermal neutralization purposes in the shape of a partially cylindrical sector, as shown in greater detail in FIG. 3, and also arranged inside said outer cylindrical body 1.

Said heating means 2 and said thermal-neutralization means 3 are in the shape of complementary sectors of a same cylinder and, as a result, they are capable of being associated to each other in the manner shown in FIG. 1, ie. in such a manner as to be capable of jointly determine an outer volume that is exactly cylindrical. The related outer cylindrical surface is allowed to exactly correspond to the inner cylindrical surface 5 of said outer cylindrical body 1, so as this is shown in the Figures, in such a way as to enable said component members, ie. the cylindrical body 1, the heating means 2 and the non-heated means 3, to form a single rigid apparatus that is firmly joined together.

In particular, in the case of asymmetrical containers, it has been found that the angular spread “g°” of said heating means, as measured with respect to the axis “X”, or axis of symmetry, of the preform, must be greater than 180°.

The way in which such an apparatus is due to operate can at this point be readily understood: the preforms 6 are inserted in the cylindrical space 7 provided inside said elements 2 and 3, and are heated up by the heating means 2. Since the latter is capable of only heating up the preform in correspondence of the surface thereof that faces it, and which most obviously is in the geometrical shape of a sector of a cylinder, and since the unheated portion of the preform is on the contrary facing the element 3, which is not heated and may possibly even be cooled down, it ensues that the cylindrical body of the preform is solely heated up on said portion of surface that faces the heating element and is in the geometrical shape of a sector of a cylinder, as shown in FIGS. 4 to 7.

The present invention can be adapted to fit several and various types of preforms, as well as various types of desired heating profiles or patterns or even different amounts of heat delivered to, ie. different heat input rates and, therefore, respective different temperatures. Anyway, all these different physical and functional configurations of the apparatus according to the present invention are fully within the ability of those skilled in the art who shall therefore be capable of identifying the related optimum parameters on the basis of simple experimental investigations and test routines.

The invention lends itself to a number of advantageous improvements, the first one of which relates to the temperature conditioning of the afore cited thermal-neutralization element 3. It may in fact occur that this element 3, although it is not heated directly, may progressively heat up by both conduction and radiation in the course of the long, uninterrupted conditioning sequences performed to handle very large amounts of successively heated preforms.

As a matter of fact, it has been found that, for a preform to be able to exhibit a thermal profile that can be used effectively to the desired purpose, the temperatures between the various zones of the surface thereof shall not differ from each other by less than 20° C.

It can be readily appreciated that the above mentioned indirect heating effect may in the long run end up by badly upsetting the thermal profile of the preforms, thereby causing it to even significantly deviate from the desired one. In order to do away with such a drawback, it would therefore be desirable to provide for the non-heated element 3 to be appropriately cooled down through a forced cooling of the outer cylindrical body 1 that can be carried out with the aid of a number of well-known means and methods.

A second improvement consists in providing said heating means 2 by forming it out of a plurality of individual elements 2a, 2b, 2c, etc., which are constituted by elongated elements that are substantially similar in their outer dimensions and parallel to each other, as this is best shown in FIGS. 1 and 2.

These individual elements may be provided with electrical heating resistances having respective differentiated ratings, in such a manner as to make it possible for the heat-treatment, which the preforms are due to undergo, to be finely adjusted and improved in view of providing the same preforms with a thermal profile that is optimised in view of the requirements of both the subsequent blow-moulding operation and the utilization of the final container.

With reference to FIGS. 10 to 13, the present invention also covers the provision of asymmetrical blow-moulding cavities that are provided with a particular apparatus adapted to carry out the process described below. In other words, the blowing mould, further to the asymmetrical cavity 10 and the stretching rod 11, is also provided with a counter-rod 12, which is arranged in alignment with said stretching rod 11 on the opposite side thereof with respect to the blow-moulding cavity.

This counter-rod 12 is delimited at its end portions by a terminal zone 13, which is oriented towards the interior of the blow-moulding cavity and, therefore, towards the stretching rod, and by the opposite terminal zone 14. The counter-rod 12 is further provided slidably within an appropriate housing in such a manner as to ensure that the sliding axis “S” of the stretching rod is the same as the one of this counter-rod.

In addition, the movement and the position of this counter-rod are controllable and actuatable pneumatically; to this purpose, in fact, the outer terminal zone 14 thereof is provided with a piston 15 that is adapted to be guided within a channel 16 provided in a body 17 that is firmly joined to or integral with said blow-moulding cavity. Such a piston 15 is actuatable pneumatically by means of a forced flow of gas that is let into and blown off said channel 16 in a controlled manner.

Said counter-rod 12 is therefore adapted to be pushed into said blow-moulding cavity 10 until the terminal zone 13 thereof is brought to almost come into contact with, ie. touch the bottom 18 of the preform and, by interrupting the pressure exerted by the gas let into the channel 16, it can be ejected out of said blow-moulding cavity owing to the pushing action exerted by the bottom of the preform being in turn pushed in the same direction by the stretching rod.

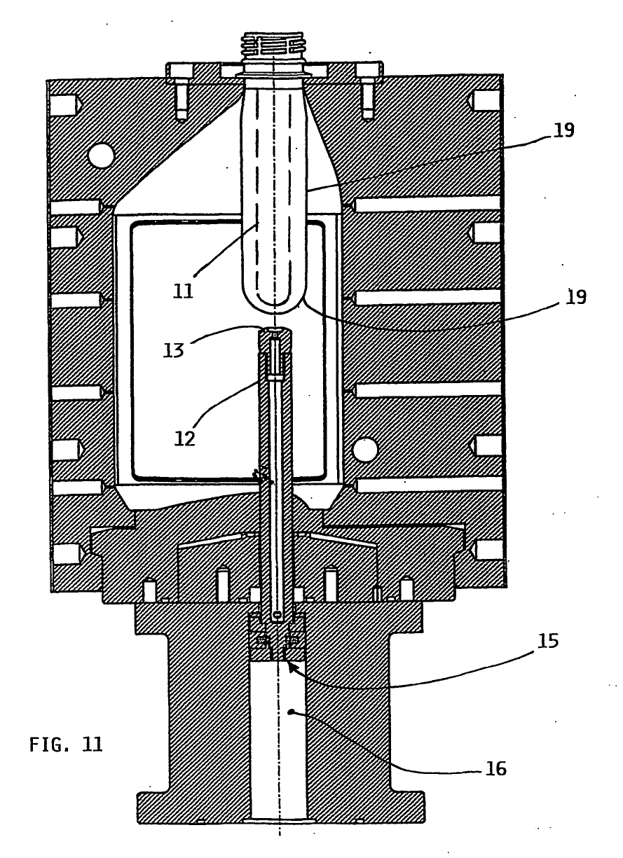

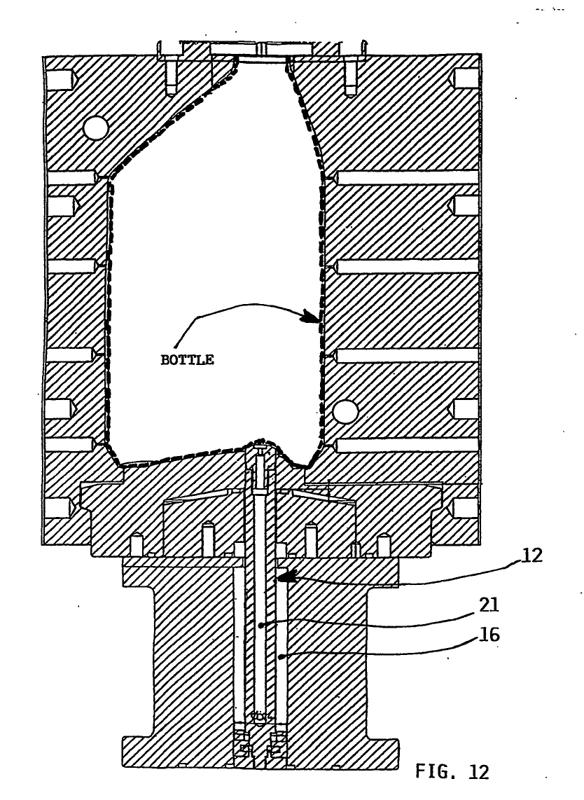

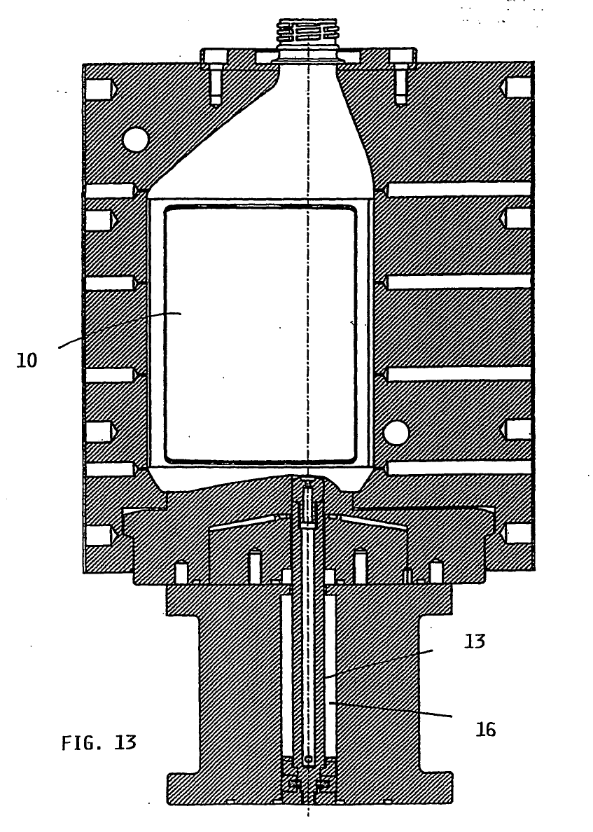

The way in which the present invention actually works should at this point be fully apparent: in a first sub-step (FIG. 10), the preform 19 is inserted in the blow-moulding cavity, while the counter-rod 12 had been previously withdrawn to the outside of the same cavity; in a subsequent sub-step (FIG. 11), said counter-rod 12 is pushed forward pneumatically until the terminal zone 13 thereof reaches a position at a minimum distance from, but not in contact with the outer wall of the bottom of the preform.

In the subsequent sub-step (FIG. 12), the preform is blow-moulded under admittance of gas under pressure into said preform, while the stretching rod is at the same time caused to fully move into the preform itself. During this sub-step, the bottom of the preform 19 enters into contact with the terminal zone 13 of the counter-rod, which is therefore pushed outwards with a movement that is fully synchronous with the movement of the stretching rod on the other side.

Therefore, since the bottom wall of the preform is in this way clamped, with an obviously controllable pressure, between the opposite terminal portions of the stretching rod and the counter-rod, said bottom wall is guided in a constrained manner and with a rectilinear motion towards the correct final position on the bottom of the blow-moulding cavity, with the desired result of preventing said bottom wall of the preform from suffering any possible warping or uncontrolled distortion.

Upon conclusion of this blow-moulding sub-step, the counter-rod 12 is retained in the final position reached by it through an appropriate decompression in said channel 16, or with the aid of other means known in the art, and the blowing mould is opened, so that the blow-moulded hollow body can eventually be removed therefrom according to any of the conventional methods used to this purpose (FIG. 13).

The above illustrated process is then repeated starting from the sub-step that has been described at the beginning. It may also be considered as being still more advantageous, in view of avoiding the risk of the bottom of the preform possibly undergoing some warping or distortion even prior to the beginning of the actual blow-moulding sub-step, if the counter-rod 12 is inserted in the mould cavity, and is allowed to stop in a position quite close to the bottom of the preform, prior to the stretching rod 11 being itself inserted in the preform. Anyway, such a reversal in the initial motions of the stretching rod and the counter-rod would by no way alter the sequence and the way in which the subsequent sub-steps are carried out.

It has however been found that the fact that the counter-rod is pressed against the bottom of the preform 19 may give rise to a drawback in that the preform itself may get stuck to said terminal zone 13 of the counter-rod and this would of course give rise to difficulties in the ejection of the hollow body from the mould after blow-moulding.

In order to do away with such a drawback, an advantageous improvement of the present invention consists in providing said counter-rod 12 with an inner longitudinal cavity 21 communicating with the outside of said terminal zone 13, ie. the one which enters into contact with the preform, through a plurality of through-perforations 22 (FIG. 14).

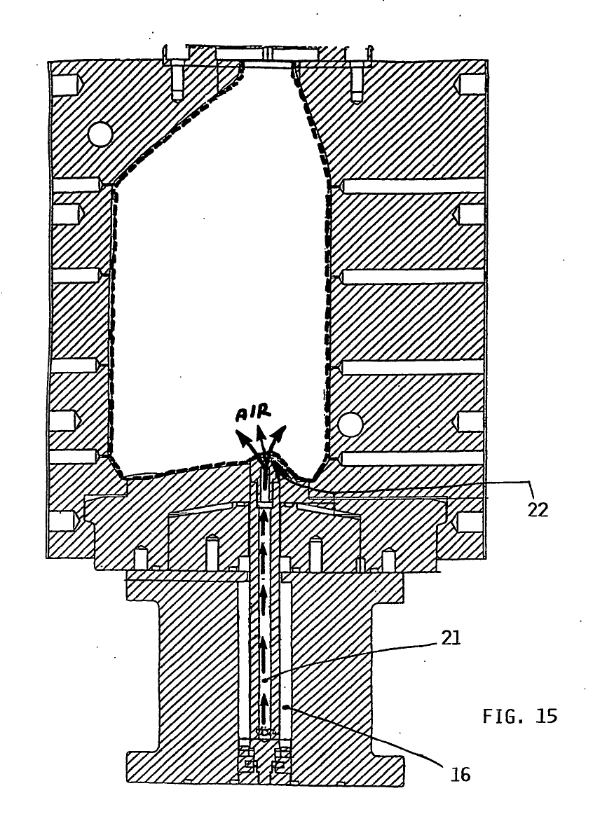

Such a cavity 21 is connected to a gas source, the delivery of which is capable of being controlled both in the timing and the pressure of the gas supply. The operation of the thus resulting counter-rod 12 therefore consists, further to its already described sliding motion into the blow-moulding cavity, in issuing gas jets from said through-perforations 22 upon completion of the blow-moulding sub-step and prior to the opening of the blowing mould, in such a manner as to enable these gas jets to promote the separation of said terminal zone 13 of the counter-rod from the bottom of the blow-moulded hollow body, so as to free the latter from any constraint that might affect or slow down a correct removal thereof from the mould (FIG. 15).

1. Manufacturing method for producing a continuous sequence of hollow bodies of thermoplastic resin in a process that is generally mown as a “single-stage” or “single-step” one, comprising the sub-steps in which:
a flow of molten plastic mass is injected into a plurality of moulds comprising a multiplicity of moulding cavities, so as to obtain a respective multiplicity of substantially cylindrical preforms;
said preforms are removed from the respective moulds and are then conveyed into temperature-conditioning stations;
said preforms are allowed to dwell in these temperature-conditioning stations for a pre-determined period of time;
said preforms are then transferred into respective blowing moulds; and
said preforms are eventually blow-moulded so as to produce said hollow bodies,
characterized in that during said sub-step in which said preforms are allowed to dwell in said temperature-conditioning stations, said preforms are caused to undergo an asymmetrical heat-treatment process, in which for each preform a definite surface sector having an angular spread (g°), as measured with respect to the axis “X” of the preform, of a pre-determined value, but in no case smaller than 180°, is heated in a different manner.

2. Manufacturing method according to claim 1, characterized in that said asymmetrical heat-treatment process comprises heating up said sector (g) of the surface of a preform with the aid of a plurality of heating means (2) arranged in a partially crown-like manner around the respective preform.

3. Manufacturing method according to claim 1 or 2, characterized in that said asymmetrical heat-treatment process generates a temperature difference, between said sector (g°) and the remaining portion of the surface of the preform, which is not lower than 20° C.

4. Manufacturing method according to any of the preceding claims, characterized in that during said asymmetrical heat-treatment process the preform is held motionless with respect to the heating source.

5. Apparatus for temperature-conditioning a continuous sequence of previously moulded preforms of thermoplastic resin that are conveyed thereto and made available there with the help of automatic handling and conveying means, comprising means adapted to heat up for a pre-determined period of time, or up to a pre-set temperature value, the outer surface of said preforms, characterized in that said heating means comprise a plurality of outer cylindrical bodies (1) adapted to accommodate respective preforms for a predetermined period of time, in which each one of said outer bodies (1) are provided in its interior with a plurality of heating means (2) arranged in a circular or crown-like manner all along a sector (g°) of the inner surface (5) of the respective outer body (1).

6. Apparatus according to claim 5, characterized in that inside said outer body (1) there is arranged, in a zone that is not occupied by said sector of said inner surface (5), a non-heated and possibly cooled-down element (3) projecting towards the centre (X) of the respective preform.

7. Apparatus according to claim 6, characterized in that said non-heated element (3) has, towards the centre of the respective preform, a surface in the shape of a sector of a cylinder.

8. Apparatus according to claim 6 or 7, characterized in that said outer cylindrical bodies (1) are cooled down.

9. Apparatus according to any of the claims 6 to 8, characterized in that each one of said heating means (2) comprises a plurality of individual elongated, substantially similar and parallel elements (2a, 2b, 2c).

10. Apparatus according to claim 9, characterized in that said individual elements (2a, 2b, 2c) are adapted to deliver mutually differentiated heat outputs.

11. Manufacturing method for producing a continuous sequence of hollow bodies of thermoplastic resin according to the preamble of claim 1, characterized in that said blow-moulding step comprises following sub-steps in which:
the preform (19) is inserted in the respective cavity of the blowing mould;
the stretching rod (11) is inserted in the interior of said preform (19) until it comes almost in contact with the bottom (18) of said preform, without however touching it;
a stretching counter-rod (12), which is arranged in alignment with said stretching rod, is approached to the preform, from the outside thereof, up to a point at which an end portion (13) of said counter-rod is brought in close proximity of the portion of the bottom of the preform that lies on the opposite side with respect to said stretching rod;
said preform is finally blow-moulded and said stretching rod is at the same time moved forward, so that the latter is caused to press against the bottom zone of the preform which in turn is in this way capable of pushing said end portion (13) of said counter-rod in the direction of ejection from said blowing mould cavity.

12. Manufacturing method according to claim 11, characterized in that after said sub-step in which the preform (19) is blow-moulded and said stretching counter-rod is ejected from the blowing mould cavity, a controlled-pressure gas flow is caused to be issued from said end portion (13) of said counter-rod, so as to promote the separation of the hollow body from the bottom of the mould cavity.

13. Apparatus for blow-moulding a continuous sequence of preforms of thermoplastic resin, comprising at least an asymmetrical blow-moulding cavity (10), in which the body of a respective preform (13) is inserted, appropriate means for blowing compressed gas into the mouth of said preform, a stretching rod (11) adapted to move into said preform through said mouth thereof and to press in a controlled manner, and by a definite stroke, against the bottom of the preform, characterized in that it is further provided with a counter-rod (12) that is provided with an end portion (13) adapted to engage against a portion of the outer surface of the bottom of the opposite preform and to exert a controlled pressure upon said bottom portion.

14. Apparatus according to claim 13, characterized in that said counter-rod is provided with a longitudinal inner cavity (21), and said end portion (13) is provided with a plurality of through-perforations (22) between the outer surface thereof and said longitudinal inner cavity, and that there are arranged means adapted to blow in a controlled manner compressed gas into said cavity in such a way as to enable said gas to be ejected through said plurality of through-perforations.
